(19) United States
(12) Patent Application Publication
(10) Pub. No.: US 2010/0293923 A1
(43) Pub. Date: Nov. 25, 2010

(54) METHOD AND APPARATUS FOR CONTROLLING AN EXHAUST THROTTLE VALVE OF AN INTERNAL COMBUSTION ENGINE

(75) Inventor: Tatsuhisa Yokoi, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi, Aichi-ken (JP)

(21) Appl. No.: 12/740,792

(22) PCT Filed: Oct. 17, 2008
(86) PCT No.: PCT/IB2008/002757

§ 371 Date: Apr. 30, 2010

(30) Foreign Application Priority Data
Oct. 30, 2007 (JP) 2007-282207

(51) Int. Cl. F02B 27/04; F01N 1/00; F02D 28/00

(52) U.S. Cl. 60/273; 60/324; 701/102

(57) ABSTRACT

If it is determined that a precondition (S108, S110, S112) for closing an exhaust throttle valve is not satisfied (“NO”) during removal of PM, auxiliaries that are an air-conditioner, a radio, and an electric fan are turned off. If the precondition is actually satisfied (“YES”) by increasing the likelihood that the precondition is satisfied, it is possible to reduce the opening amount of the exhaust throttle valve (S114). Therefore, the bed temperature of a particulate filter (DPF) is controlled stably, and a sufficient bed temperature is maintained. As a result, the DPF is recovered promptly. In this way, excessive increases in the exhaust gas temperature and the exhaust gas back pressure are not caused, and it is therefore possible to protect an internal combustion engine and to control the opening amount of the exhaust throttle valve appropriately. As a result, it is possible to remove particulate matter stably.

### BACKGROUND OF THE INVENTION

1. Field of the Invention

The invention relates to an opening amount control device and opening amount control method for an exhaust throttle valve for an internal combustion engine, which adjusts the operating state of the internal combustion engine by controlling the opening amount of the exhaust throttle valve that is arranged in an exhaust passage of the internal combustion engine.

2. Description of the Related Art

A particulate filter that traps particulate matter in exhaust gas is used to purify the exhaust gas discharged from a diesel engine. To prevent clogging of the particulate filter, the particulate matter accumulated in the particulate filter is burned, whereby the particulate filter is recovered, as described in Japanese Patent Application Publication No. 2007-16653 (JP-A-2007-16653) and Japanese Patent Application Publication No. 2006-152870 (JP-A-2006-152870).

According to JP-A-2007-16653 and JP-A-2006-152870, an exhaust throttle valve is provided, and the opening amount of the exhaust throttle valve is controlled to adjust the bed temperature of a particulate filter. In this way, the particulate filter is effectively recovered. More specifically, when the bed temperature of the particulate filter is low, the opening amount of the exhaust throttle valve is reduced to increase the back pressure and the temperature of the exhaust gas. Thus, the amount of heat that is transferred from the exhaust gas to the particulate filter is increased to increase the bed temperature of the particulate filter. On the other hand, when the bed temperature of the particulate filter is excessively high, the opening amount of the exhaust throttle valve is increased to reduce the back pressure and the temperature of the exhaust gas. Thus, the amount of heat transferred from the exhaust gas to the particulate filter is reduced to suppress an increase in the bed temperature of the particulate filter.

The temperature and the back pressure of the exhaust gas are increased based not only on the opening amount of the exhaust throttle valve but also on the operating state of an internal combustion engine. Increases in the temperature and the back pressure of the exhaust gas may be caused when a load that is placed on the internal combustion engine is increased, for example, by turning on an auxiliary (e.g. air-conditioner, radio, and electric fan) that is driven using the power output from the internal combustion engine.

When there is a possibility that increases in the temperature and the back pressure of the exhaust gas will be caused by turning on the auxiliary, the opening amount of the exhaust throttle valve, which has been closed, is increased in order to protect the internal combustion engine and to prevent an excessive increase in the bed temperature of the particulate filter, according to JP-A-2007-16653 and JP-A-2006-152870.

However, if the exhaust throttle valve is opened, the bed temperature of the particulate filter is actually not controlled stably. This may arise a possibility that a sufficient bed temperature will not be maintained and therefore the particulate filter will not recovered promptly.

### SUMMARY OF THE INVENTION

The invention provides an opening amount control device and opening amount control method for an exhaust throttle valve for an internal combustion engine, with which excessive increases in the exhaust gas temperature and the exhaust gas back pressure are not caused and it is therefore possible to control the opening amount of the exhaust throttle valve appropriately and to protect the internal combustion engine.

A first aspect of the invention relates to an opening amount control device for an exhaust throttle valve for an internal combustion engine, which adjusts the operating state of the internal combustion engine by controlling the opening amount of the exhaust throttle valve that is arranged in an exhaust passage of the internal combustion engine. The control device includes: a precondition determination unit that determines whether a precondition for reducing the opening amount of the exhaust throttle valve is satisfied; an exhaust throttle valve opening amount reduction unit that reduces the opening amount of the exhaust throttle valve when the precondition determination unit determines that the precondition is satisfied; and an internal combustion engine operating state adjustment unit that adjusts a physical quantity, which indicates the operating state of the internal combustion engine and which is used to determine whether the precondition is satisfied, in such a manner that a likelihood that the precondition is satisfied is increased, when the precondition determination unit determines that the precondition is not satisfied.

A second aspect of the invention relates to a method for controlling an opening amount of an exhaust throttle valve that is arranged in an exhaust passage of an internal combustion engine, thereby adjusting an operating state of the internal combustion engine. The method includes: determining whether a precondition for reducing the opening amount of the exhaust throttle valve is satisfied; reducing the opening amount of the exhaust throttle valve when it is determined that the precondition is satisfied; and adjusting a physical quantity, which indicates the operating state of the internal combustion engine and which is used to determine whether the precondition is satisfied, in such a manner that a likelihood that the precondition is satisfied is increased, when it is determined that the precondition is not satisfied.

According to the first and second aspects of the invention described above, when it is determined that the precondition for reducing the opening amount of the exhaust throttle valve is not satisfied, the physical quantity, which indicates the operating state of the internal combustion engine and which is used to determine whether the precondition is satisfied, is adjusted in such a manner that the likelihood that the precondition is satisfied is increased

After the likelihood that the precondition is satisfied is increased, it is determined again whether the precondition is satisfied. If it is determined that the precondition is satisfied at this time, the exhaust throttle valve opening amount reduction unit is able to reduce the opening amount of the exhaust throttle valve.

If it is determined that the precondition is not satisfied, it is not possible to reduce the opening amount of the exhaust throttle valve in the current operating state of the internal combustion engine. However, even in this state, if the internal combustion engine operating state adjustment unit is operated, the opening amount of the exhaust throttle valve is reduced. Because it is possible to reduce the opening amount of the exhaust throttle valve, the manner for adjusting the opening amount of the exhaust throttle valve comes close to or matches the regular manner.

Accordingly, excessive increases in the exhaust gas temperature and the exhaust gas back pressure are not caused, and it is therefore possible to protect the internal combustion engine and to control the opening amount of the exhaust throttle valve appropriately.

In the first and second aspect of the invention described above, the state of recovery of a particulate filter that is arranged in the exhaust passage of the internal combustion engine may be adjusted by controlling the opening amount of the exhaust throttle valve that is arranged downstream of the particulate filter.

Because it is possible to reduce the opening amount of the exhaust throttle valve, it is possible to control the bed temperature of the particulate filter stably during recovery of the particulate filter and to maintain a sufficient bed temperature. As a result, it is possible to recover the particulate filter promptly.

Accordingly, excessive increases in the exhaust gas temperature and the exhaust gas back pressure are not caused, and it is therefore possible to protect the internal combustion engine and to control the opening amount of the exhaust throttle valve appropriately. Therefore, it is possible to remove the particulate matter stably.

In the first and second aspects of the invention described above, the opening amount of the exhaust throttle valve may be reset to an original value, when it is determined that the precondition is not satisfied after the opening amount of the exhaust throttle valve is reduced.

After the opening amount of the exhaust throttle valve is reduced, the precondition may be unsatisfied for some reason during removal of the particulate matter. In this case, the opening amount of the exhaust throttle valve is reset to the original value. Thus, it is possible to prevent excessive increases in the exhaust gas temperature and the exhaust gas back pressure during removal of the particulate matter.

In the first and second aspects of the invention described above, the physical quantity that indicates the operating state of the internal combustion engine may be at least one physical quantity that influences a bed temperature of the particulate filter.

As the physical quantity that indicates the operating state of the internal combustion engine and that is used to determine whether the precondition is satisfied, the physical quantity that influences the bed temperature of the particulate filter is used. Thus, it is possible to control the bed temperature of the particulate filter stably during recovery of the particulate filter and to maintain a sufficient bed temperature. As a result, it is possible to recover the particulate filter promptly.

In the first and second aspects of the invention described above, the physical quantity that influences the bed temperature of the particulate filter may be at least one of a fuel supply amount, an exhaust gas temperature and an exhaust gas back pressure.

The physical quantity that influences the bed temperature of the particulate filter is at least one of the fuel supply amount, the exhaust gas temperature and the exhaust gas back pressure. Thus, excessive increases in the exhaust gas temperature and the exhaust gas back pressure are not caused, and it is therefore possible to protect the internal combustion engine and control the opening amount of the exhaust throttle valve appropriately. As a result, it is possible to recover the particulate filter promptly.

In the first and second aspects of the invention described above, the precondition may be unsatisfied when one of the physical quantities exhibits a value that is on the higher-load side with respect to a reference value that indicates a limit value for durability of the internal combustion engine, whereas the precondition may be satisfied when each of all the physical quantities exhibits a value that is not on the higher-load side with respect to the reference value.

If a determination as to whether the precondition is satisfied is made as described above, excessive increases in the exhaust gas temperature and the exhaust gas back pressure are not caused, and it is therefore possible to protect the internal combustion engine and to control the opening amount of the exhaust throttle valve appropriately.

In the first and second aspects of the invention described above, the physical quantity may be adjusted in such a manner that the likelihood that the precondition is satisfied is increased by stopping an operation of an auxiliary that is driven using power output from the internal combustion engine.

The energy that is consumed by the internal combustion engine is reduced by stopping the operation of the auxiliary. Therefore, the exhaust gas temperature and the exhaust gas back pressure are not increased easily. Accordingly, the likelihood that the precondition is satisfied is increased. As a result, it is possible to reduce the opening amount of the exhaust throttle valve.

Thus, excessive increases in the exhaust gas temperature and the exhaust gas back pressure are not caused, and it is therefore possible to protect the internal combustion engine and to control the opening amount of the exhaust throttle valve appropriately.

In the first and second aspects of the invention, a determination as to whether the precondition is satisfied may be deferred by a predetermined stand-by time after the physical quantity is adjusted in such a manner that the likelihood that the precondition is satisfied is increased by stopping the operation of the auxiliary.

When a load placed on the internal combustion engine is reduced, the stand-by mode is continued until the engine operating state is stabilized. If a determination is made after the predetermined stand-by time has elapsed, it is possible to secure higher reliability of the determination as to whether the precondition is satisfied. This is because the determination is made after the operating state of the internal combustion engine is stabilized.

In the first and second aspects of the invention described above, the auxiliary may include at least one of an air-conditioner and an electrically-powered unit.

At least one of the air-conditioner and the electrically-powered unit is used as the auxiliary. If it is determined that the precondition is not satisfied, the likelihood that the precondition is satisfied is increased by stopping the auxiliary.

In the first aspect of the invention, the precondition determination unit, the exhaust throttle valve opening amount reduction unit and the internal combustion engine operating state adjustment unit may operate when the particulate filter is recovered in response to a manual operation.

A command to perform a manual operation to recover the particulate filter is issued when it is difficult to recover the particulate filter, that is, when the engine speed and the load placed on the internal combustion engine are low. When the recovery of the particulate filter is started in response to the manual operation, it is necessary to increase the engine speed and the load placed on the internal combustion engine to efficiently burn the particulate matter. Therefore, the necessity to increase the fuel supply amount and close the exhaust throttle valve increases. Therefore, increasing the likelihood that the precondition is satisfied is important. According to the first aspect of the invention described above, when it is determined that the precondition is not satisfied, the likelihood that the precondition is satisfied is increased by operating the internal combustion engine operating state adjustment unit. As a result, it is possible to reduce the opening amount of the exhaust throttle valve.

Thus, even when the particulate filter is recovered in response to a manual operation, excessive increases in the exhaust gas temperature and the exhaust gas back pressure are not caused, and it is therefore possible to protect the internal combustion engine and to control the opening amount of the exhaust throttle valve appropriately. As a result, the particulate filter is recovered stably.

### BRIEF DESCRIPTION OF THE DRAWINGS

The features, advantages and technical and industrial significances of this invention will be better understood by reading the following detailed description of example embodiments of the invention, when considered in connection with the accompanying drawings, in which:

FIG. 1 is a view schematically showing the structure of a diesel engine and a control system thereof according to a first embodiment of the invention;

FIG. 2 is a flowchart showing a part of an exhaust throttle valve opening amount control routine that is executed by an ECU according to the first embodiment of the invention;

FIG. 3 is a flowchart showing another part of the exhaust throttle valve opening amount control routine;

FIG. 4 is a flowchart showing a fuel supply control routine;

FIG. 5 is a flowchart showing a fuel supply control routine that is executed by an ECU according to a second embodiment of the invention;

FIG. 6 is a flowchart showing a part of an exhaust throttle valve opening amount control routine that is executed by an ECU according to a third embodiment of the invention;

FIG. 7 is a flowchart showing a part of an exhaust throttle valve opening amount control routine that is executed by an ECU according to a fourth embodiment of the invention; and

FIG. 8 is a graph showing the configuration of an exhaust throttle valve opening/closing map.

### DETAILED DESCRIPTION OF THE EXAMPLE EMBODIMENTS

In the following description and the accompanying drawings, the invention will be described in greater detail with reference to example embodiments.

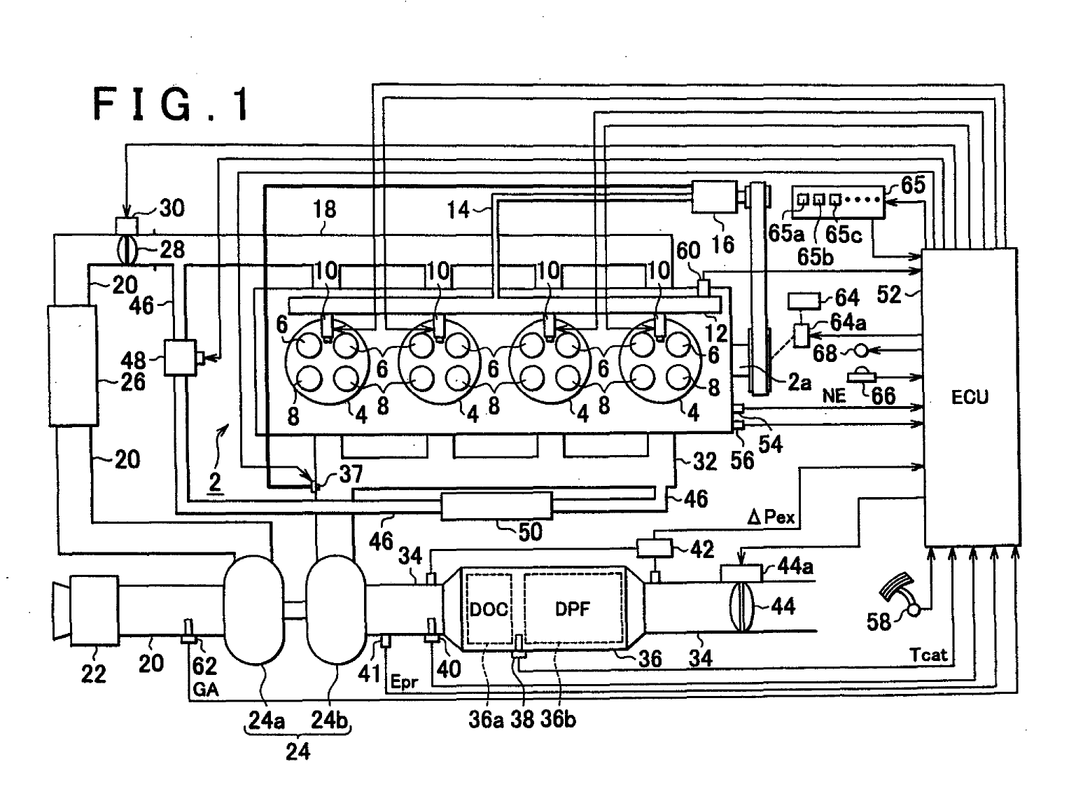

First, a first embodiment of the invention will be described. FIG. 1 is a view schematically showing the structure of a diesel engine (hereinafter, referred to as “engine”) 2 that serves as an internal combustion engine to which the invention is applied, and a control system for the engine 2. The engine 2 is an internal combustion engine for driving a vehicle, and the vehicle travels using the drive power output from the engine 2. Each of cylinders 4 of the internal combustion engine 2 is provided with intake valves 6, exhaust valves 8, and a fuel injection valve 10 that injects fuel directly into a combustion chamber.

The fuel injection valves 10 communicate with a common rail 12 in which fuel is accumulated until a predetermined pressure is achieved, and the common rail 12 communicates, via a fuel supply pipe 14, with a fuel pump 16 that is rotated using the power from the engine 2. The pressurized fuel is distributed from the common rail 12 to the fuel injection valves 10 of the respective cylinders 4. The fuel injection valve 10 is opened in response to application of a predetermined drive current to the fuel injection valve 10. As a result, the fuel is injected from the fuel injection valve 10 into the cylinder 4.

An intake manifold 18 is connected to the engine 2, and branch pipes of the intake manifold 18 communicate with the combustion chambers of the respective cylinders 4 via intake ports. The intake manifold 18 is connected to an intake pipe 20, and an upstream-side portion of the intake pipe 20 is connected to an air cleaner 22. A compressor 24a of a turbocharger 24 is arranged at a middle portion of the intake pipe 20. The compressor 24a compresses intake air using the rotation of a turbine 24b.

An intercooler 26 that cools the intake air, which has been compressed by the compressor 24a and which has an increased temperature, is arranged in the intake pipe 20 at a position downstream of the compressor 24a. An intake throttle valve 28 that adjusts the intake air amount is fitted to the intake pipe 20 at a position downstream of the intercooler 26, and the opening amount of the intake throttle valve 28 is adjusted by an electric actuator 30.

An exhaust manifold 32 is connected to the engine 2, and branch pipes of the exhaust manifold 32 communicate with the combustion chambers of the respective cylinders 4 via exhaust ports. The exhaust manifold 32 is connected to an exhaust pipe 34 via the turbine 24b of the turbocharger 24. A turbine wheel arranged in the turbine 24b rotates upon reception of the pressure of the exhaust gas, and the rotational drive power is transferred from the turbine 24b to the compressor 24a.

An exhaust gas control apparatus 36 is arranged at a middle portion of the exhaust pipe 34. An oxidation catalyst (hereinafter, referred to as “DOC”) 36a and a particulate filter (hereinafter, referred to as “DPF”) 36b are arranged in the exhaust gas control apparatus 36. The DOC 36a is arranged upstream of the DPF 36b. A catalyst bed temperature sensor 38 is arranged between the DOC 36a and the DPF 36b, and detects the temperature of the exhaust gas that flows from the DOC 36a into the DPF 36b as the bed temperature. An exhaust gas temperature sensor 40 is arranged upstream of the exhaust gas control apparatus 36, and detects the temperature of the exhaust gas that flows into the exhaust gas control apparatus 36. In addition, an exhaust gas back pressure sensor 41 is arranged between the turbine 24b and the exhaust gas control apparatus 36, and detects an exhaust gas back pressure Epr. Further, an exhaust gas differential pressure sensor 42 detects an exhaust gas differential pressure ΔPex, which is a pressure difference between the upstream side and the downstream side of the exhaust gas control apparatus 36.

The exhaust manifold 32 is provided with a fuel supply valve 37 to which the fuel is supplied from the fuel pump 16. When the particulate matter needs to be removed from the DPF 36b, the fuel is supplied into the exhaust gas from the fuel supply valve 37. In this way, the fuel is supplied to the exhaust gas control apparatus 36. The fuel is oxidized in the DOC 36a, and heat is produced. Therefore, the bed temperature of the DPF 36b is increased, and the particulate matter accumulated in the DPF 36b is burned.

An exhaust throttle valve 44 that adjusts the flow rate of the exhaust gas is arranged in the exhaust pipe 34 at a position downstream of the exhaust gas control apparatus 36. The exhaust throttle valve 44 is opened and closed by an actuator 44a. A portion of the exhaust gas that flows in the exhaust manifold 32 is introduced into the intake manifold 18 through an exhaust gas recirculation passage (EGR passage) 46. An EGR valve 48 that adjusts the flow rate of the EGR gas that flows through the EGR passage 46 is arranged at a middle portion of the EGR passage 46. An EGR cooler 50 that cools the EGR gas is arranged in the EGR passage 46 at a position upstream of the EGR valve 48.

The engine 2 is provided with an electronic control unit (ECU) 52 that controls the engine operating state. The ECU 52 is a control circuit that controls an engine operation based on the engine operating state and a command from a driver. The ECU 52 is formed mainly of a microcomputer that includes a CPU, a ROM, a RAM, a backup RAM, etc.

The catalyst bed temperature sensor 38, the exhaust gas temperature senor 40, the exhaust gas back pressure sensor 41, and the exhaust gas differential pressure sensor 42 described above are connected to the ECU 52. In addition, a crank angle sensor 54 that detects the rotational speed of a crank shaft 2a of the engine 2 (engine speed NE), a coolant temperature sensor 56 that detects the temperature of an engine coolant, and an accelerator pedal operation amount sensor 58 that detects an operation amount of an accelerator pedal (accelerator pedal operation amount) are connected to the ECU 52. Further, a fuel pressure sensor 60 that detects the pressure of the fuel in the common rail 12, an intake air amount sensor 62 that detects an intake air amount GA, auxiliary operating switches 65, a manual recovery switch 66, and other sensors and switches are connected to the ECU 52. With this structure, signals output from various sensors and switches are input in the ECU 52. The auxiliary operating switches 65 include, for example, an air-conditioner switch 65a, a radio switch 65b, and an electric fan switch 65c. When the air-conditioner switch 65a is turned on, a clutch 64a is engaged. Therefore, a rotational force is transferred from the crankshaft 2a of the engine 2 to a compressor of an air conditioner 64 via the clutch 64a, whereby the air conditioner 64 is driven. When the radio switch 65b is turned on, a radio operates using electric energy from a battery which is charged with electricity generated by an alternator that is rotated by the crankshaft 2a. When the electric fan switch 65c is turned on, an electric fan that is used for air-conditioning in a vehicle compartment operates using the electric energy from the battery.

The fuel injection valves 10, the EGR valve 48, the actuator 30 for the intake throttle valve 28, the actuator 44a for the exhaust throttle valve 44, and the clutch 64a are electrically connected to the ECU 52, whereby the ECU 52 controls operations of these mechanisms. In addition, the ECU 52 illuminates a DPF lamp 68 in order to notify the driver to manually issue a command for recovering the DPF 36b, when the amount of particulate matter accumulated in the exhaust gas control apparatus 36 reaches a value at which a manual operation needs to be performed to recover the DPF 36b (when the amount of accumulated particulate matter is equal to or larger than a reference value A described later in detail).

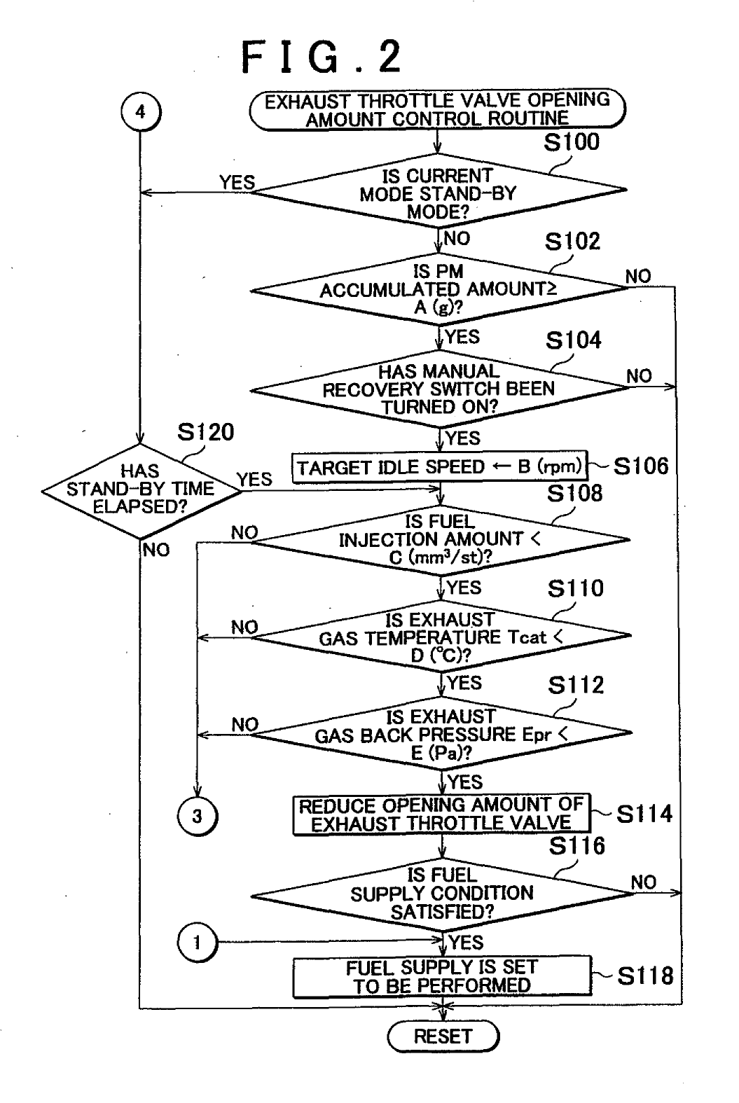

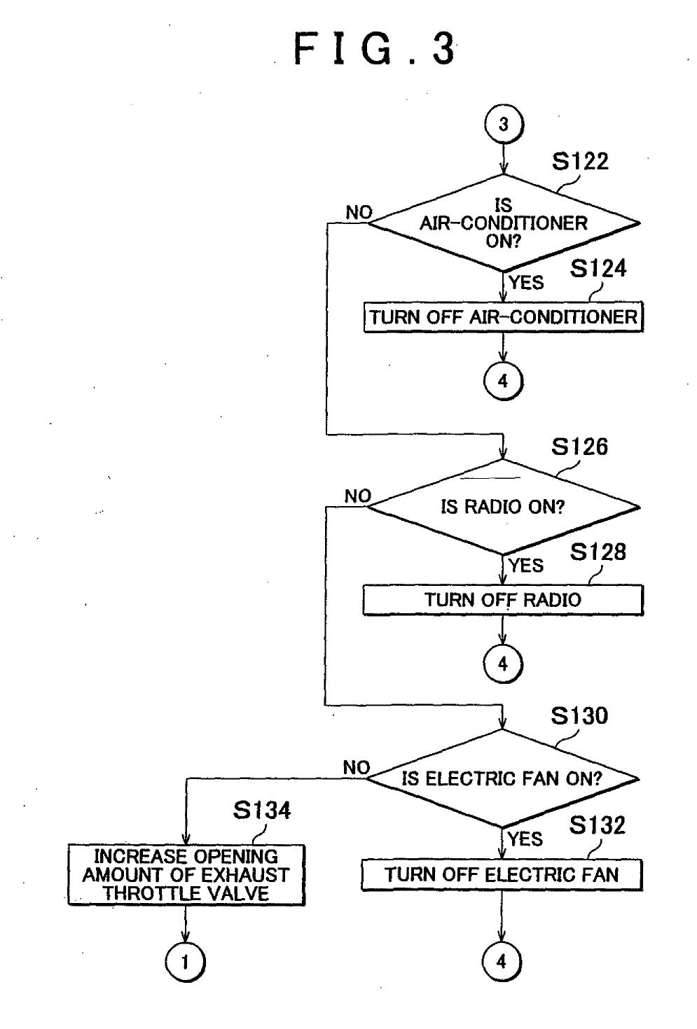

Next, an exhaust throttle valve opening amount control routine that is executed by the ECU 52 will be described in detail with reference to flowcharts in FIGS. 2 and 3. The control routine is executed in an interrupt manner at predetermined time intervals or at predetermined crank angle intervals. Each step in the flowcharts will be denoted by “S”.

When the control routine (FIGS. 2 and 3) is started, first, it is determined whether the current mode is a stand-by mode (S100). When a load placed on the engine 2, described later in detail, is reduced, the stand-by mode is continued until the engine operating state is stabilized. When the control routine is executed for the first time, a negative determination is made in S100 (“NO” in S100) because the stand-by time has not been set yet. Then, it is determined whether the amount of particulate matter accumulated in the DPF 36b (hereinafter, referred to as “PM accumulated amount”) is equal to or larger than a reference value A(g) (S102). Estimated calculation of the PM accumulated amount has been performed based on the engine operating state and the particulate filter recovery state. The reference value A is set as a manual recovery required PM accumulated amount, and used to determine whether the PM accumulated amount has reached a PM accumulated amount at which a command to perform a manual operation needs to be issued to recover the DPF 36b.

If it is determined that the PM accumulated amount is smaller than the reference value A (PM accumulated amount<A) (“NO” in S102), the control routine is reset. Then, when the PM accumulated amount is increased due to a continuous operation of the engine 2 and it is determined that the PM accumulated amount is equal to or larger than the reference value A (“YES” in S102), it is determined whether the driver has turned on the manual recovery switch 66 (S 104). If the driver has not turned on the manual recovery switch 66 (“NO” in S104) even when the DPF lamp 68 is illuminated as described above, the control routine is reset.

If the driver presses the manual recovery switch 66 in response to the illumination of the DPF lamp 68 when the vehicle stops (“YES” in S104), the target idle speed is set to a manual recovery-time idle speed B (rpm: e.g. 1200 rpm) (S106).

Then, it is determined whether the amount of fuel injected from the fuel injection valve 10, which is the amount of fuel supplied to the engine 2, is smaller than a reference fuel injection amount C (mm³/st) (S108). The reference fuel injection amount C is a reference value that is used to determine whether the exhaust throttle valve 44 should be closed or opened. If the fuel injection amount is smaller than the reference fuel injection amount C, one of the preconditions for closing the exhaust throttle valve 44 is satisfied. This is because, when the fuel injection amount is smaller than the reference fuel injection amount C, even if the exhaust throttle valve 44 is closed, overheating of the exhaust gas and overheating of the exhaust gas control apparatus 36 due to the overheating of the exhaust gas are not caused easily.

If it is determined that the fuel injection amount is smaller than the reference fuel injection amount C (“YES” in S108), it is determined whether an exhaust gas temperature Tcat (° C.) that is detected by the exhaust gas temperature sensor 40 is lower than a reference exhaust gas temperature D (S110). The reference exhaust gas temperature D is a reference value that is used to determine whether the exhaust throttle valve 44 should be closed or opened. If the exhaust gas temperature Teat is lower than the reference exhaust gas temperature D, one of the preconditions for closing the exhaust throttle valve 44 is satisfied. This is because, when the exhaust gas temperature Tcat is lower than the reference exhaust gas temperature D, even if the exhaust throttle valve 44 is closed, overheating of the exhaust gas and overheating of the exhaust control apparatus 36 due to the overheating of the exhaust gas are not caused easily.

If it is determined that the exhaust gas temperature Tcat is lower than the reference exhaust gas temperature D (“YES” in S110), it is determined whether an exhaust gas back pressure Epr (Pa) that is detected by the exhaust gas back pressure sensor 41 is lower than a reference exhaust gas back pressure E (S112). The reference exhaust gas back pressure E is a reference value that is used to determine whether the exhaust throttle valve 44 should be closed or opened. If the exhaust gas back pressure

Epr is lower than the reference exhaust gas back pressure E, one of the preconditions for closing the exhaust throttle valve 44 is satisfied. This is because, when the exhaust gas back pressure Epr is lower than the reference exhaust gas back pressure E, even if the exhaust throttle valve 44 is closed, overheating of the exhaust gas and overheating of the exhaust gas control apparatus 36 due to the overheating of the exhaust gas are not caused easily.

Only when all of the three conditions in S108, S110 and S112 are satisfied (only when an affirmative determination is made in each of all S108, S110 and S112), it is determined that the precondition for reducing the opening amount of the exhaust throttle valve 44 (closing the exhaust throttle valve 44, in this case) is satisfied. That is, the reference fuel injection amount C, the reference exhaust gas temperature D and the reference exhaust gas back pressure E are used as the reference values that indicate limit values for the durability.

If all of these three conditions are satisfied (“YES” in S108, “YES” in S110, and “YES” in S112), the actuator 44a for the exhaust throttle valve 44 is driven to close the exhaust throttle valve 44 (S114).

Then, it is determined whether a fuel supply condition is satisfied (S116). For example, when the engine speed NE is in transition and therefore it is unstable, the fuel supply condition is not satisfied. If it is determined that the fuel supply condition is not satisfied (“NO” in S116), the control routine is reset.

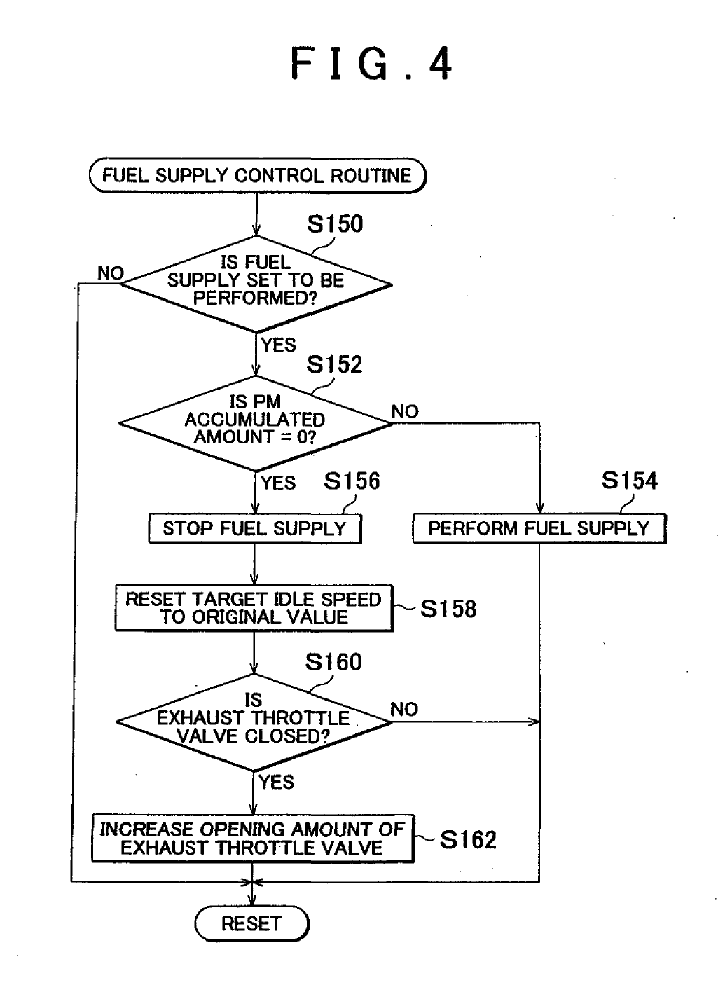

On the other hand, if it is determined that the fuel supply condition is satisfied (“YES” in S116), the fuel supply is set to be performed (S118). Then, a substantive process is executed according to a fuel supply control routine shown in the flowchart in FIG. 4.

The fuel supply control routine (FIG. 4) is executed in an interrupt manner at predetermined time intervals or predetermined crank angle intervals. In the fuel supply control routine (FIG. 4), first, it is determined whether the fuel supply is set to be performed (S150). If it is determined that the fuel supply is not set to be performed unlike in the case of S118 (“NO” in S150), the control routine is reset.

On the other hand, if it is determined that the fuel supply is set to be performed in S118 in FIG. 2 (“YES” in S150), it is determined whether the PM accumulated amount is zero (S152). When the control routine is executed for the first time, the PM accumulated amount is larger than zero (“NO” in S152). Therefore, the fuel supply is performed to remove the particulate matter as the particulate filter recovery control (S154). That is, the fuel is sprayed into the exhaust gas from the fuel supply valve 37, and the fuel is supplied into the exhaust gas control apparatus 36 along with the exhaust gas. Thus, the fuel is oxidized in the DOC 36a of the exhaust gas control apparatus 36 and heat is produced, and the exhaust gas, of which the temperature is increased by the heat, increases the temperature of the DPF 36b that is arranged downstream of the DOC 36a. Then, the bed temperature of the DPF 36b increases due to an increase in the temperature of the DPF 36b, whereby the particulate matter accumulated in the DPF 36b is burned.

After that, as long as the PM accumulated amount is larger than zero (“NO” in S152), the particulate matter is continuously removed by supplying fuel into the exhaust gas. When the PM accumulated amount is brought to zero by burning the particulate matter (“YES” in S152), the fuel supply is stopped (S156). Then, the target idle speed is reset to the original value (the target idle speed that is used when removal of the particulate matter is not started) (S158).

Then, it is determined whether the exhaust throttle valve 44 is closed (S160). If S144 in FIG. 2 has been already executed, the exhaust throttle valve 44 has been closed (“YES” in S160). Therefore, the opening amount of the exhaust throttle valve 44 is increased, in this case, the exhaust throttle valve 44 is fully opened (S162), after which the control routine is reset. If removal of the particulate matter is executed with the exhaust throttle valve 44 kept open as described later in detail, a negative determination is made in S160, after which the control routine is reset.

If an affirmative determination is made in S152, the fuel supply is set not to be executed. Therefore, in the subsequent control routine and the following control routines, it is determined that the fuel supply is not set to be performed (“NO” in S150). Therefore, a substantive process according to the fuel supply control routine (FIG. 4) ends.

If it is determined that one of the preconditions in S108, S110 and S112 is not satisfied, that is, one of physical quantities shown in S108, S110 and S112 is on a high-load side with respect to the reference value (equal to or larger than the reference value), it is determined whether the air-conditioner 64 is on (S122). That is, it is determined whether the clutch 64a is engaged. If it is determined that the aid-conditioner 64 is on based on the state of the air-conditioner switch 65a (“YES” in S122), the air-conditioner 64 is forcibly turned off (S124). That is, power transfer between a compressor of the air-conditioner 64 and the crankshaft 2a is shut off by disengaging the clutch 64a, whereby a load placed on the engine 2 is reduced.

Then, it is determined whether the stand-by time has elapsed after the air-conditioner 64 is turned off (S120). The stand-by time is set in order to defer the determinations as to whether the preconditions are satisfied (S108, S110, S112) until the fuel injection amount, the exhaust gas temperature Teat and the exhaust gas back pressure

Epr are stabilized after the load placed on the engine 2 by the air-conditioner 64 is removed. At first, the stand-by time has not elapsed after the air-conditioner 64 is turned off (“NO” in S120). Therefore, the control routine is reset.

In the subsequent control routine, because the current mode is the stand-by mode (“YES” in S100), it is immediately determined whether the stand-by time has elapsed (S120). After that, as long as the stand-by time has not elapsed, the state in which an affirmative determination is made in S100 and a negative determination is made in S120 continues.

If it is determined that the stand-by time has elapsed (“YES” in S120), it is determined whether the preconditions in S108, S110 and S112 are satisfied. If all the preconditions in S108, S110 and S112 are satisfied by turning off the air-conditioner 64, the exhaust throttle valve 44 is closed as described above (S114). If the fuel supply condition is satisfied (“YES” in S116), S118 is executed to execute the fuel supply control routine (FIG. 4) in order to remove the particulate matter.

Even when it is determined that the stand-by time has elapsed after the air-conditioner 64 is turned off (“YES” in S120), if one of the preconditions in S108, S110 and S112 is not satisfied (“NO” in one of S108, S110, and S112), it is determined again whether the air-conditioner 64 is on (S122). However, because it is determined that the air-conditioner 64 has been already turned off (“NO” in S122), it is determined whether the radio is on (S126). If it is determined that the radio switch 65b is on (“YES” in S126), the radio switch 65b is forcibly turned off (S128). Thus, an electric load that is placed on the engine 2 due to the operation of the radio is removed, whereby the load placed on the engine 2 is reduced.

Then, it is determined whether the stand-by time has elapsed after the radio switch 65b is turned off (S120). The stand-by time is set to defer the determinations as to whether the preconditions in S108, S110 and S112 are satisfied until the fuel injection amount, the exhaust gas temperature Teat and the exhaust gas back pressure Epr are stabilized after the electric load placed on the engine 2 by the radio is removed. At first, the stand-by time has not elapsed yet (“NO” in S120) after the radio switch 65b is turned off. Therefore, the control routine is reset.

In the subsequent control routine, because the current mode is the stand-by mode (“YES” in S100), it is immediately determined whether the stand-by time has elapsed (S120). After that, as long as the stand-by time has not elapsed, the state in which an affirmative determination is made in S100 and a negative determination is made in S120 continues.

If it is determined that the stand-by time has elapsed (“YES” in S120), it is determined whether the preconditions in S108, S110 and S112 are satisfied. If all the preconditions in S108, S110 and S112 are satisfied by turning off the radio, the exhaust throttle valve 44 is closed as described above (S114). If the fuel supply condition is satisfied (“YES” in S116), S118 is executed to execute the fuel supply control routine (FIG. 4) in order to remove the particulate matter.

Even when it is determined that the stand-by time has elapsed after the radio is turned off (“YES” in S120), if one of the preconditions in S108, S110 and S112 is not satisfied (“NO” in one of S108, S110, and S112), it is determined again whether the air-conditioner 64 is on (S122). However, because it is determined that the air-conditioner 64 has been already turned off (“NO” in S122), it is determined whether the radio is on (S126). Because it is determined that the radio has been already turned off (“NO” in S126), it is determined whether the electric fan is on (S130). If it is determined that the electric fan switch 65c is on (“YES” in S130), the electric fan switch 65c is forcibly turned off (S132). Thus, an electric load that is placed on the engine 2 due to the operation of the electric fan is removed, whereby the load placed on the engine 2 is reduced.

Then, it is determined whether the stand-by time has elapsed after the electric fan switch 65c is turned off (S120). The stand-by time is set to defer the determinations as to whether the preconditions in S108, S110 and S112 are satisfied until the fuel injection amount, the exhaust gas temperature Tcat and the exhaust gas back pressure Epr are stabilized after the electric load placed on the engine 2 by the electric fan is removed. At first, the stand-by time has not elapsed (“NO” in S120) after the electric fan switch 65c is turned off. Therefore, the control routine is reset.

In the subsequent control routine, because the current mode is the stand-by mode (“YES” in S100), it is immediately determined whether the stand-by time has elapsed (S120). After that, as long as the stand-by time has not elapsed, the state in which an affirmative determination is made in S100 and a negative determination is made in S120 continues.

If it is determined that the stand-by time has elapsed (“YES” in S120), it is determined whether the preconditions in S108, S110 and S112 are satisfied. If all the preconditions in S108, S110 and S112 are satisfied by turning off the electric fan, the exhaust throttle valve 44 is closed as described above (S114). If the fuel supply condition is satisfied (“YES” in S116), S118 is executed to execute the fuel supply control routine (FIG. 4) in order to remove the particulate matter.

Even when it is determined that the stand-by time has elapsed after the electric fan is turned off (“YES” in S120), if one of the preconditions in S108, S110 and S112 is not satisfied (“NO” in one of S108, S110, and S112), it is determined again whether the air-conditioner 64 is on (S122). However, because it is determined that the air-conditioner 64 has been already turned off (“NO” in S122), it is determined whether the radio is on (S126). Because it is determined that the radio has been already turned off (“NO” in S126), it is determined whether the electric fan is on (S130). Because it is determined that the electric fan has been already turned off (“NO” in S130), the opening amount of the exhaust throttle valve 44 is increased. If the exhaust throttle valve 44 has been already open, the exhaust throttle valve 44 is kept open.

Then, the fuel supply is set to be performed (S118). Therefore, the fuel supply control routine (FIG. 4) is executed to remove the particulate matter with the exhaust throttle valve 44 kept open. In this case, when removal of the particulate matter is completed, a negative determination is made in S160 in FIG. 4, after which the control routine is reset immediately.

In the above-described configuration, the ECU 52 controls the opening amount of the exhaust throttle valve of the internal combustion engine. The ECU 52 performs functions of determining whether the preconditions are satisfied, reducing the opening amount of the exhaust throttle valve, and adjusting the operating state of the internal combustion engine. In S108, S110, and S112 in the exhaust throttle valve opening amount control routine (FIGS. 2 and 3), it is determined whether the preconditions are satisfied. In S114, the opening amount of the exhaust throttle valve is reduced. In S122 to S132, the operating state of the internal combustion engine is adjusted.

The first embodiment of the invention described above produces the following effects. A) If it is determined that one of the preconditions in S108, S110 and S112 for closing the exhaust throttle valve 44 in order to remove the particulate matter is not satisfied, the physical quantity that indicates the operating state of the internal combustion engine is adjusted. In the determination as to whether the precondition is satisfied, the physical quantity is compared with the reference value. In this case, the physical quantity that exerts an influence on the bed temperature of the DPF 36b, for example, the fuel injection amount (corresponding to the fuel supply amount), the exhaust gas temperature Tcat, or the exhaust gas back pressure Epr is adjusted. Such adjustment is made by turning off the auxiliary, for example, the air-conditioner 64, the radio or the electric fan (S122 to S132), whereby the likelihood that the preconditions are satisfied is increased. When the preconditions in S108, S110 and S112 are actually satisfied as a result of increasing the likelihood that the preconditions are satisfied, it is possible to reduce the opening amount of the exhaust throttle valve 44 (S114).

Therefore, even if it is not possible to reduce the opening amount of the exhaust throttle valve 44 in the current engine operating state, the exhaust throttle valve 44 is closed by adjusting the fuel injection amount, the exhaust gas temperature Teat or the exhaust gas back pressure Epr.

As described above, it is possible to close the exhaust throttle valve 44. Therefore, the bed temperature of the DPF 36b is stably controlled, and a sufficient bed temperature is maintained. As a result, the DPF 36b is recovered promptly. In this way, excessive increases in the exhaust gas temperature and the exhaust gas back pressure are not caused, and it is therefore possible to protect the internal combustion engine and to control the opening amount of the exhaust throttle valve appropriately. Therefore, the particulate matter is removed stably.

B) The process for removing the particulate matter in the exhaust throttle valve opening amount control routine (FIGS. 2 and 3) is executed on the condition that the manual recovery switch 66 has been turned on. A command to perform a manual operation is issued to recover the DPF 36b, when the load placed on the engine 2, for example, the fuel injection amount, and the engine speed NE are low, that is, when it is difficult to remove the particulate matter.

Therefore, when removal of the particulate matter is started in response to the manual operation, the necessity of increasing, for example, the amount of fuel injected from the fuel injection valve 10 and closing the exhaust throttle valve 44 is increased in order to increase the engine speed NE and the load placed on the engine 2. Therefore, it is important to increase the likelihood that the preconditions in S108, S110 and S112 are satisfied. In the first embodiment of the invention, when it is determined that one of the preconditions is not satisfied (“NO” in one of S108, S110 and S112), the likelihood that the preconditions are satisfied is increased by turning off the air-conditioner 64, the radio, or the electric fan (S122 to S132). Therefore, it is possible to close the exhaust throttle valve 44.

Therefore, even when the particulate matter is removed in response to a manual operation, excessive increases in the exhaust gas temperature and the exhaust gas back pressure are not caused, and it is therefore possible to protect the internal combustion engine and to control the opening amount of the exhaust throttle valve appropriately. Therefore, the particulate matter is removed stably.

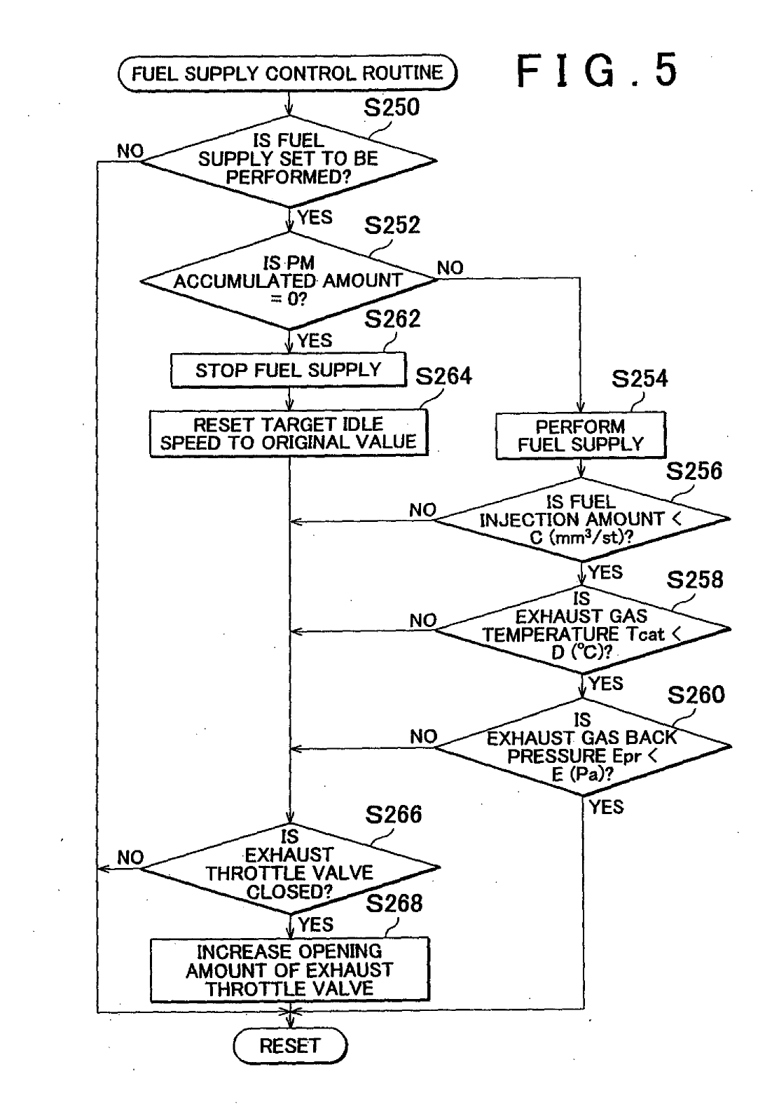

Next, a second embodiment of the invention will be described. In the second embodiment of the invention, the routine in FIG. 5 is executed instead of the routine in FIG. 4 as the fuel supply control routine. The routine in FIG. 5 is also executed in an interrupt manner at predetermined time intervals or predetermined crank angle intervals. The other configurations are the same as those in the first embodiment of the invention. Therefore, description concerning the other configurations will be provided with reference to FIGS. 1 to 3.

The fuel supply control routine in FIG. 5 will be described. S250 to S254, and S262 to S268 are the same as S150 to S162 in FIG. 4. The routine in FIG. 5 differs from the routine in FIG. 4 in that S256 to S260 are executed after the fuel supply is performed (S254).

If it is determined that the preconditions in S108, S110 and S112 are satisfied and therefore the exhaust throttle valve 44 is closed (S114), and then the fuel supply is set to be performed (“YES” in S116, S118) in the exhaust throttle valve opening amount control routine (FIGS. 2 and 3), an affirmative determination is made in S250 in the fuel supply control routine (FIG. 5), and a substantive process is started. Because the PM accumulated amount is larger than zero when the control routine is executed for the first time (“NO” in S252), the fuel is supplied from the fuel supply valve 37 with the exhaust throttle valve 44 kept closed (S254), whereby the particulate matter removal process is executed. Then, S256, 5258, and S260 are executed. The preconditions in S256, S258, and S260 are the same as the preconditions in S108, S110 and S112 in the exhaust throttle valve opening amount control routine (FIGS. 2 and 3).

That is, as long as all the preconditions are satisfied (“YES” in S256, “YES” in S258, and “YES” in S260), the particulate matter removal process is executed with the exhaust throttle valve 44 kept closed, as in the first embodiment of the invention.

However, if one of the preconditions in S256, S258 and S260 becomes unsatisfied while the particulate matter removal process is executed with the exhaust throttle valve 44 kept closed, it is determined in S266 whether the exhaust throttle valve 44 is closed. Because the exhaust throttle valve 44 is kept closed at this time (“YES” in S266), the exhaust throttle valve 44 is opened (S268).

In the subsequent control routine, as long as the PM accumulated amount is larger than zero (“NO” in S252), the fuel supply is performed (S254). If one of the preconditions in S256, S258 and S260 is still unsatisfied, it is determined whether the exhaust throttle valve 44 is closed. However, because the exhaust throttle valve 44 has been already opened (“NO” in S266), the control routine is reset. Therefore, the particulate matter removal process is continued with the exhaust throttle valve 44 kept open.

When all the preconditions in S256, S258 and S260 are satisfied, the control routine is reset. Therefore, the exhaust throttle valve 44 is kept open. Accordingly, as long as the PM accumulated amount is larger than zero (“NO” in S252), the particulate matter removal process is executed with the exhaust throttle valve 44 kept open. When the PM accumulated amount becomes zero (“YES” in S252), the fuel supply is stopped (S262), and the target idle speed is reset to the original target idle speed (S264). Because the exhaust throttle valve 44 is kept open (“NO” in S266), the control routine is reset. In the subsequent control routine, it is determined that the fuel supply is not set to be performed (“NO” in S250). Therefore, the substantial control process ends.

In the configuration described above, the ECU 52 controls the opening amount of the exhaust throttle valve of the internal combustion engine. The ECU 52 performs functions of determining whether the preconditions are satisfied, reducing the opening amount of the exhaust throttle valve, and adjusting the operating state of the internal combustion engine. In S108, S110 and S112 in the exhaust throttle valve opening amount control routine (FIGS. 2 and 3) and S256, S258 and S260 in the fuel supply control routine (FIG. 5), it is determined whether the preconditions are satisfied. In S114, the opening amount of the exhaust throttle valve is reduced. In S122 to S132, the operating state of the internal combustion engine is adjusted. In S266 and S268, the opening amount of the exhaust throttle valve is increased.

The second embodiment of the invention produces the following effects. A) The effects produced by the first embodiment of the invention are produced also by the second embodiment of the invention. That is, excessive increases in the exhaust gas temperature and the exhaust gas back pressure are not caused, and it is therefore possible to protect the internal combustion engine and to control the opening amount of the exhaust throttle valve appropriately. Therefore, the particulate matter is removed stably.

In addition, if one of the preconditions in S256, S258 and S260 becomes unsatisfied for some reasons during removal of the particulate matter after the exhaust throttle valve 44 is closed, the exhaust throttle valve 44 is opened.

Thus, it is possible to avoid the situation in which the exhaust gas temperature or the exhaust gas back pressure excessively increase during removal of the particulate matter.

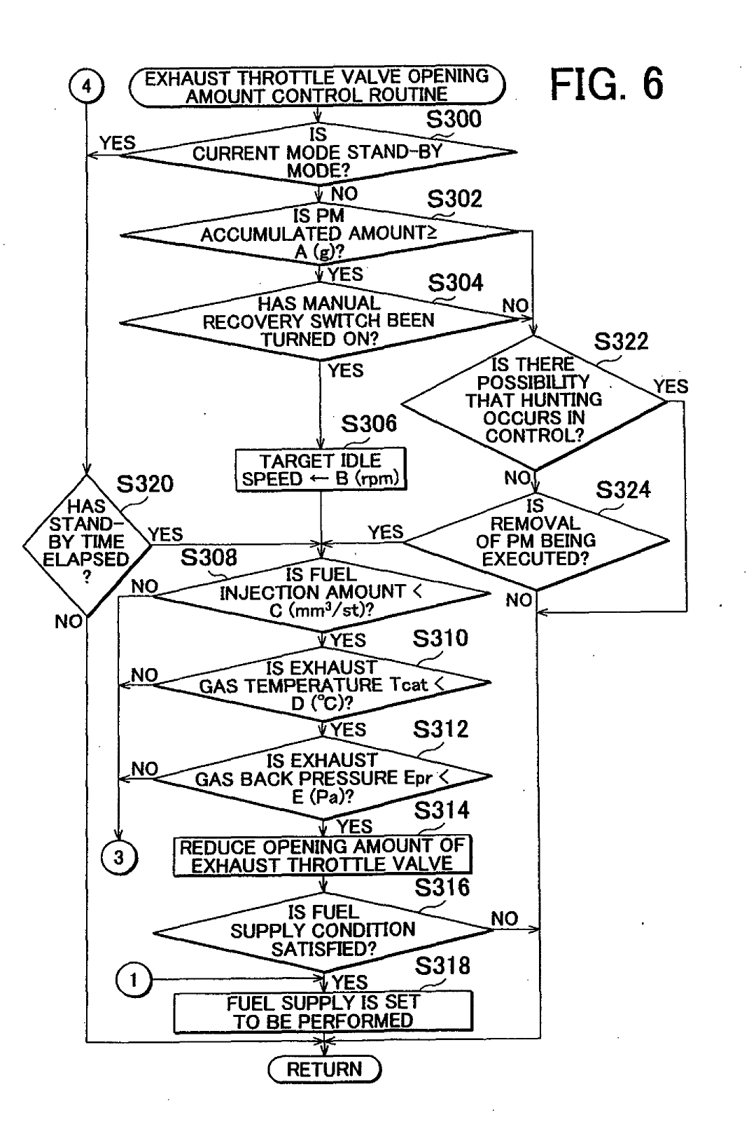

Next, a third embodiment of the invention will be described. In the third embodiment of the invention, the routine in FIG. 6 is executed instead of the routine in FIG. 2 in the exhaust throttle valve opening amount control routine (FIGS. 2 and 3). The other configurations are the same as those in the first embodiment of the invention. Therefore, description on the other configurations will be provided with reference to FIGS. 1, 3 and 4.

The exhaust throttle valve opening amount control routine (FIG. 6) will be described below. S300 to S312 and S314 to S320 are the same as S100 to S120 in FIG. 2. In FIG. 6, after a negative determination is made in S302 or S304, it is determined in S322 whether there is a possibility that hunting will occur in the control instead of resetting the control routine immediately. If one of the preconditions in S308, S310 and S312 becomes unsatisfied during removal of the particulate matter, the exhaust throttle valve 44 is opened. After that, it is determined again whether the preconditions in S308, S310 and S312. In this case, there is a possibility that the preconditions in S308, S310 and S312 will be satisfied again and hunting will occur in the control. In order to prevent occurrence of hunting, S322 is executed.

If it is determined that there is no possibility that hunting will occur in the control (“NO” in S322), it is determined whether removal of the particulate matter is being executed (S324). If it is determined that removal of the particulate matter is not being executed (“NO” in S324), the control routine is reset immediately. On the other hand, if it is determined that removal of the particulate matter is being executed (“YES” in S324), it is determined whether the preconditions S308, S310 and S312 are satisfied.

Therefore, even when the particulate matter removal process is executed with the exhaust throttle valve 44 kept closed (“YES” in S324), it is determined whether the preconditions in S308, S310 and S312 are satisfied. If it is determined that one of the preconditions is not satisfied, the routine shown in FIG. 3 is executed and the load placed on the engine 2 by the auxiliary is reduced (S122 to S132), as described above. If the preconditions in S308, S310 and S312 are satisfied again as a result of reduction in the load placed on the engine 2 by the auxiliary, S314 is executed. Therefore, the exhaust throttle valve 44 is kept closed.

If one of the preconditions in S308, S310 and S312 is not satisfied even if all the loads placed on the engine 2 by the auxiliaries are reduced (S122 to S132), the exhaust throttle valve 44 is opened (S134).

In the subsequent control routine, there is a possibility that the preconditions in S308, S310 and S312 will be satisfied again because the exhaust throttle valve 44 is opened, and hunting will occur in the control (“YES” in S322). Therefore, the control routine is reset without executing S324. Thus, it is not determined whether the preconditions in S308, S310 and S312 are satisfied, and the exhaust throttle valve 44 is kept open. As a result, hunting in the control is prevented.

In the configuration described above, the ECU 52 controls the opening amount of the exhaust throttle valve of the internal combustion engine. The ECU 52 performs functions of determining whether the preconditions are satisfied, reducing the opening amount of the exhaust throttle valve, and adjusting the operating state of the internal combustion engine. In S308, S310, and S312 in the exhaust throttle valve opening amount control routine (FIGS. 6 and 3), it is determined whether the preconditions are satisfied. In S314, the opening amount of the exhaust throttle valve is reduced. In S122 to S132, the operating state of the internal combustion engine is adjusted. In S134, the opening amount of the exhaust throttle valve is increased.

The third embodiment of the invention produces the following effects. A) The effects produced by the first embodiment of the invention are produced also by the third embodiment of the invention. That is, excessive increases in the exhaust gas temperature and the exhaust gas back pressure are not caused, and it is therefore possible to protect the internal combustion engine and to control the opening amount of the exhaust throttle valve appropriately. Therefore, the particulate matter is removed stably.

In addition, if one of the preconditions in S256, S258 and S260 becomes unsatisfied for some reasons during removal of the particulate matter after the exhaust throttle valve 44 is closed, the load placed on the engine 2 by the auxiliary is reduced (S122 to S132) before the exhaust throttle valve 44 is opened (S134). Thus, the exhaust throttle valve 44 is kept closed as long as possible.

Thus, even if the exhaust gas temperature or the exhaust gas back pressure excessively increases during removal of the particulate matter, the exhaust gas temperature or the exhaust gas back pressure is reset to the original value with the exhaust throttle valve 44 kept closed. Thus, the bed temperature of the DPF 36b is controlled more reliably, which makes it possible to recover the DPF 36b sufficiently promptly. In this way, excessive increases in the exhaust gas temperature and the exhaust gas back pressure are not caused, and it is therefore possible to protect the internal combustion engine and to control the opening amount of the exhaust throttle valve appropriately.

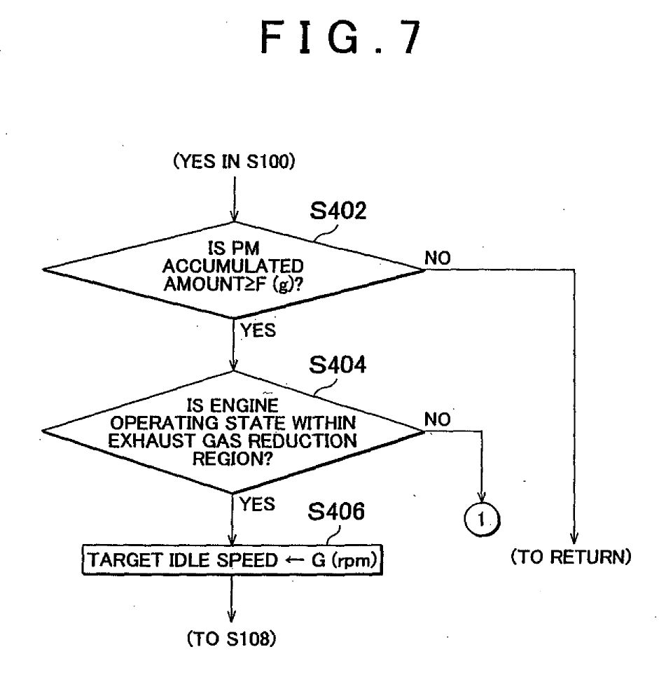

Next, a fourth embodiment of the invention will be described. In the fourth embodiment of the invention, the routine shown in FIG. 7 (S402 to S406) is executed instead of S102 to S106 in FIG. 2 in the exhaust throttle valve opening amount control routine (FIGS. 2 and 3). The exhaust throttle valve opening amount control routine (FIGS. 2, 3, and 7) is started when the particulate matter removal process is executed in a regular manner, that is, when the particulate matter removal process is executed automatically. Thus, the loads placed on the engine 2 by the auxiliaries are adjusted when the automatic particulate matter removal mode is executed, for example, when the vehicle is traveling normally. The other configurations are the same as those in the first embodiment of the invention.

In order to determine whether the automatic particulate matter removal mode is executed, first, it is determined whether the PM accumulated amount is equal to or larger than a reference value F (S402). The reference value F is set as a regular recovery required PM accumulated amount, and used to determine whether the PM accumulated amount has reached a PM accumulated amount at which a command to automatically recover the DPF 36b should be issued.

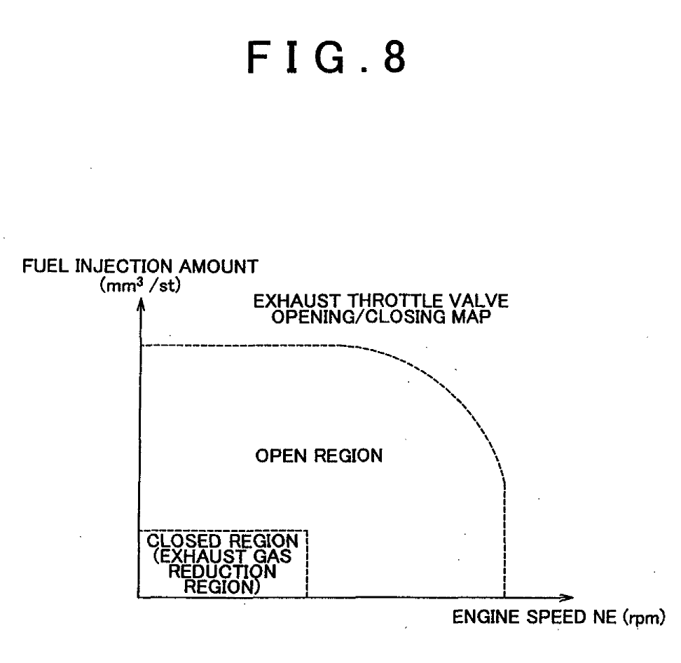

If it is determined that the PM accumulated amount is smaller than the reference value F (“NO” in S402), the control routine is reset. On the other hand, if it is determined that the PM accumulated amount is equal to or larger than the reference value F (“YES” in S402), it is determined whether the current engine operating region is the region in which the amount of exhaust gas is reduced by reducing the opening amount of the exhaust throttle valve 44, that is, the region in which the exhaust throttle valve 44 is closed (S404), The region in which the exhaust throttle valve 44 is closed (exhaust gas reduction region) is as shown in an exhaust gas throttle valve opening/closing map in FIG. 8. That is, the region in which both the amount (mm³/st) of fuel injected from the fuel injection valve 10, which corresponds to the engine load, and the engine speed NE (rpm) are small is the region in which the exhaust throttle valve 44 is closed because the exhaust gas back pressure and the exhaust gas temperature are low. The other region, that is, the region in which at least one of the fuel injection amount (mm³/st) and the engine speed NE (rpm) is large is the region in which the exhaust throttle valve 44 is open because the exhaust gas back pressure and the exhaust gas temperature are high.

When the engine operating state is not within the exhaust gas reduction region shown in FIG. 8 (“NO” in S404), no command to close the exhaust throttle valve 44 has been issued. Therefore, S118 is executed. Accordingly, the particulate matter removal process is executed with the exhaust throttle valve 44 kept open.

On the other hand, when the engine operating state is within the exhaust gas reduction region shown in FIG. 8 (“YES” in S404), the target idle speed is set to an automatic removal-time idle speed G (S406). The automatic removal-time idle speed G is used when the engine 2 is idling. The automatic removal-time idle speed G varies depending on whether a transmission that is connected to the engine 2 is a manual transmission or an automatic transmission, the shift range of the automatic transmission, etc.

After execution of S406, S108 (FIG. 2) is executed. In the above-described configuration, the ECU 52 controls the opening amount of the exhaust throttle valve of the internal combustion engine. The ECU 52 performs functions of determining whether the preconditions are satisfied, reducing the exhaust throttle valve, and adjusting the operating state of the internal combustion engine. In S108, S110, and S112 in the exhaust throttle valve opening amount control routine (FIGS. 2, 7 and 3), it is determined whether the preconditions are satisfied. In S114, the opening amount of the exhaust throttle valve is reduced. In S122 to S132, the operating state of the internal combustion engine is adjusted.

The fourth embodiment of the invention produces the following effects. The effects A) produced by the first embodiment of the invention are produced also by the third embodiment of the invention. That is, excessive increases in the exhaust gas temperature and the exhaust gas back pressure are not caused, and it is therefore possible to protect the internal combustion engine and to control the opening amount of the exhaust throttle valve appropriately. Therefore, the particulate matter is removed stably.

Other embodiments of the invention will be described below. a) In each of the embodiments of the invention described above, the fuel is supplied toward the exhaust gas control apparatus 36 by the fuel supply valve 37. Alternatively, the fuel may be supplied toward the exhaust gas control apparatus 36 by post-injection or after-injection.

b) In each of the embodiments of the invention described above, only when all the fuel injection amount, the exhaust gas temperature and the exhaust gas back pressure are smaller than the reference values, the opening amount of the exhaust throttle valve is reduced. Alternatively, the opening amount of the exhaust throttle valve may be reduced when at least one of the fuel injection amount, the exhaust gas temperature and the exhaust gas back pressure is smaller than the reference value.

c) When the vehicle is not in motion, in addition to the radio and the electric fan, a headlight and a fog lamp may be regarded as an electrically-powered unit included in the auxiliaries.

1.-18. (canceled)

19. An opening amount control device for an exhaust throttle valve for an internal combustion engine, which adjusts an operating state of the internal combustion engine by controlling an opening amount of the exhaust throttle valve that is arranged in an exhaust passage of the internal combustion engine, comprising:
a precondition determination unit that determines whether a precondition for determining whether there is a possibility that a temperature of an exhaust gas control apparatus is increased to an excessively high temperature by reducing the opening amount of the exhaust throttle valve is satisfied;
an exhaust throttle valve opening amount reduction unit that reduces the opening amount of the exhaust throttle valve when the precondition determination unit determines that the precondition is satisfied; and
an internal combustion engine operating state adjustment unit that adjusts a physical quantity, which indicates the operating state of the internal combustion engine and which is used to determine whether the precondition is satisfied, in such a manner that a likelihood that the precondition is satisfied is increased, when the precondition determination unit determines that the precondition is not satisfied.

20. The opening amount control device according to claim 19, wherein the opening amount control device adjusts a state of recovery of a particulate filter that is arranged in the exhaust passage of the internal combustion engine by controlling the opening amount of the exhaust throttle valve that is arranged downstream of the particulate filter.

21. The opening amount control device according to claim 20, further comprising:
an exhaust throttle valve opening amount reset unit that resets the opening amount of the exhaust throttle valve to an original value, when the precondition determination unit determines that the precondition is not satisfied after the exhaust throttle valve opening amount reduction unit reduces the opening amount of the exhaust throttle valve.

22. The opening amount control device according to claim 20, wherein the physical quantity that indicates the operating state of the internal combustion engine is at least one physical quantity that influences a bed temperature of the particulate filter.

23. The opening amount control device according to claim 22, wherein the physical quantity that influences the bed temperature of the particulate filter is at least one of a fuel supply amount, an exhaust gas temperature and an exhaust gas back pressure.

24. The opening amount control device according to claim 22, wherein the precondition is not satisfied when one of the physical quantities exhibits a value that is on a higher-load side with respect to a reference value that indicates a limit value for durability of the internal combustion engine, whereas the precondition is satisfied when each of all the physical quantities exhibits a value that is not on the higher-load side with respect to the reference value.

25. The opening amount control device according to claim 20, wherein the internal combustion engine operating state adjustment unit adjusts the physical quantity in such a manner that the likelihood that the precondition is satisfied is increased by stopping an operation of an auxiliary that is driven using power output from the internal combustion engine.

26. The opening amount control device according to claim 25, wherein the precondition determination unit defers a determination as to whether the precondition is satisfied by a predetermined stand-by time after the internal combustion engine operating state adjustment unit adjusts the physical quantity in such a manner that the likelihood that the precondition is satisfied is increased by stopping the operation of the auxiliary.

27. The opening amount control device according to claim 25, wherein the auxiliary includes at least one of an air-conditioner and an electrically-powered unit.

28. The opening amount control device according to claim 20, wherein the precondition determination unit, the exhaust throttle valve opening amount reduction unit and the internal combustion engine operating state adjustment unit operate when the particulate filter is recovered in response to a manual operation.

29. A method for controlling an opening amount of an exhaust throttle valve that is arranged in an exhaust passage of an internal combustion engine, thereby adjusting an operating state of the internal combustion engine, comprising:
determining whether a precondition for determining whether there is a possibility that a temperature of an exhaust gas control apparatus is increased to an excessively high temperature by reducing the opening amount of the exhaust throttle valve is satisfied;
reducing the opening amount of the exhaust throttle valve when it is determined that the precondition is satisfied; and
adjusting a physical quantity, which indicates the operating state of the internal combustion engine and which is used to determine whether the precondition is satisfied, in such a manner that a likelihood that the precondition is satisfied is increased, when it is determined that the precondition is not satisfied.

30. The method according to claim. 29, wherein a state of recovery of a particulate filter that is arranged in the exhaust passage of the internal combustion engine is adjusted by controlling the opening amount of the exhaust throttle valve that is arranged downstream of the particulate filter.

31. The method according to claim 30, further comprising:
resetting the opening amount of the exhaust throttle valve to an original value, when it is determined that the precondition is not satisfied after the opening amount of the exhaust throttle valve is reduced.

32. The method according to claim 30, wherein the physical quantity that indicates the operating state of the internal combustion engine is at least one physical quantity that influences a bed temperature of the particulate filter.

33. The method according to claim 32, wherein the physical quantity that influences the bed temperature of the particulate filter is at least one of a fuel supply amount, an exhaust gas temperature and an exhaust gas back pressure.

34. The method according to claim 32, wherein the precondition is not satisfied when one of the physical quantities exhibits a value that is on a higher-load side with respect to a reference value that indicates a limit value for durability of the internal combustion engine, whereas the precondition is satisfied when each of all the physical quantities exhibits a value that is not on the higher-load side with respect to the reference value.

35. The method according to claim 30, wherein the physical quantity is adjusted in such a manner that the likelihood that the precondition is satisfied is increased by stopping an operation of an auxiliary that is driven using power output from the internal combustion engine.

36. The method according to claim 35, wherein a determination as to whether the precondition is satisfied is deferred by a predetermined stand-by time after the physical quantity is adjusted in such a manner that the likelihood that the precondition is satisfied is increased by stopping the operation of the auxiliary.
